(19) United States
(12) Patent Application Publication
(10) Pub. No.: US 2026/0154988 A1
(43) Pub. Date: Jun. 4, 2026

(54) SYSTEM AND METHOD FOR PRODUCING SYLLABLE-UNIT THREE-DIMENSIONAL FINGER GESTURE DATA FOR FINGER GESTURE RECOGNITION

(71) Applicant: Korea Electronics Technology Institute, Seongnam-si (KR)

(72) Inventor: Han Mu PARK, Seongnam-si (KR)

(73) Assignee: Korea Electronics Technology Institute, Seongnam-si (KR)

(21) Appl. No.: 19/400,888

(22) Filed: Nov. 25, 2025

(30) Foreign Application Priority Data
Nov. 29, 2024 (KR) 10-2024-0175498

(51) Int. Cl. G06V 40/20; G06V 10/774

(52) U.S. Cl. CPC G06V 40/28; G06V 10/774

(57) ABSTRACT

Provided are a system and a method for producing syllable-unit 3D finger language posture data for finer language gesture recognition. The data set production method according to an embodiment may estimate 3D finger language postures from phoneme-unit 2D finger language videos, may pseudo-label phoneme ground truths of finger language gestures, and may produce, as a training data set, syllable-unit 3D finger language postures and syllable ground truths of the finger language gestures by combining the estimated 3D finger language postures and the phoneme ground truths. Accordingly, insufficient training data sets may be secured through augmentation without the time and cost burden.

### CROSS-REFERENCE TO RELATED APPLICATION(S) AND CLAIM OF PRIORITY

This application is based on and claims priority under 35 U.S.C. § 119 to Korean Patent Application No. 10-2024-0175498, filed on Nov. 29, 2024, in the Korean Intellectual Property Office, the disclosure of which is herein incorporated by reference in its entirety.

### BACKGROUND

### Field

The disclosure relates to finger language recognition, and more particularly, to a system and a method for producing data sets for training a finger language recognition model through data augmentation.

### Description of Related Art

Finger language refers to a method of expressing letters by using hand movements, and a unique hand posture is defined for each letter, so that precise posture information for individual gestures is required to accurately recognize and translate finger language gestures.

Since finger language video data requires actual deaf people to take videos, it may be difficult to secure enough data, and in particular, the process of labeling three-dimensional (3D) hand posture information may cause a great cost burden.

To solve this cost issue, a data augmentation method using hand postures is required, but current finger language gesture data does not have labeling on posture information, and therefore, it is difficult to effectively augment data to improve finger language recognition performance.

### SUMMARY

The disclosure has been developed in order to solve the above-described problems, and an object of the disclosure is to provide a system and a method which estimate 3D finger language postures from phoneme-unit 2D finger language videos and pseudo-label phoneme ground truths of finger language gestures, and produces syllable-unit 3D finger language postures and syllble ground truths of finger language gestures as a training data set by combining the estimated 3D finger language postures and the phone ground truths.

According to an embodiment of the disclosure to achieve the above-described object, a syllable-unit 3D finger language posture data set production method may include: a step of estimating phoneme-unit 3D finger language postures from phoneme-unit 2D finger language videos; a first labeling step of labeling the estimated phoneme-unit 3D finger language postures with phoneme ground truths of finger language gestures which match the phoneme-unit 2D finger language videos; a first generation step of generating syllable ground truths of finger language gestures by combining the phoneme ground truths of finger language gestures; a second generation step of generating a syllable-unit 3D finger language posture by combining the phoneme-unit 3D finger language postures corresponding to respective phonemes combined with the syllable ground truths of finger language gestures; and a second labeling step of labeling the syllable-unit 3D finger language posture with the syllable ground truth of finger language gestures.

The phoneme-unit 2D finger language videos and the phoneme ground truths of finger language gestures may be pre-established in a first repository as a data set.

The phoneme-unit 2D finger language videos may be videos that are made by shooting person's finger language gestures in the unit of a phoneme.

The step of estimating may include estimating the phoneme-unit 3D finger language postures by using an AI model that is pre-trained to estimate phoneme-unit 3D finger language postures from phoneme-unit 2D finger language videos.

The first labeling step may include labeling with the phoneme-unit ground truths of finger language gestures as pseudo-ground truths of the estimated phoneme-unit 3D finger language postures.

The step of producing the syllable-unit 3D finger language posture may include combining the phoneme-unit 3D finger language postures by applying interpolation.

The second generation step may include processing linear interpolation between the phoneme-unit 3D finger language postures in combining the phoneme-unit 3D finger language postures.

The linear interpolation between the phoneme-unit 3D finger language postures may be processed by the following equation:

$${J}^{n + 1} = {J}^{n} + \{ ( a / L ) \times ( {J}^{m} - {J}^{n} ) \}$$

where a and L are hyper parameters of linear interpolation which are adjusted to adjust the speed of finger language gestures, and J^{m} and Jⁿ indicate the first 3D finger language posture of a later phoneme and the last 3D finger language posture of a prior phoneme, respectively.

According to an embodiment, the syllable-unit 3D finger language posture data set production method may further include: a step of storing the syllable-unit 3D finger language posture and the syllable ground truth of finger languages in a second repository as a training data set; and training a finger language recognition model by using the stored training data set.

The step of estimating may include: a step of estimating phoneme-unit 2D finger language postures from the phoneme-unit 2D finger language videos; and a step of converting the estimated phoneme-unit 2D finger language postures into phoneme-unit 3D finger language videos.

According to another embodiment of the disclosure, a syllable-unit 3D finger language posture data set production system may include: a labeling module configured to estimate phoneme-unit 3D finger language postures from phoneme-unit 2D finger language videos, and to label the estimated phoneme-unit 3D finger language postures with phoneme ground truths of finger language gestures which match the phoneme-unit 2D finger language videos; and a 3D posture production unit configured to generate syllable ground truths of finger language gestures by combining the phoneme ground truths of finger language gestures, to generate a syllable-unit 3D finger language posture by combining the phoneme-unit 3D finger language postures corresponding to respective phonemes combined with the syllable ground truths of finger language gestures, and to label the syllable-unit 3D finger language posture with the syllable ground truth of finger language gestures.

According to still another embodiment of the disclosure, a training system may include: a repository configured to store a training data set in which a syllable-unit 3D finger language posture is labeled with a syllable ground truth of finger language gestures; an error calculation unit configured to calculate an error by comparing a syllable of finger language gestures that is estimated by a finger language recognition model to be trained by receiving a syllable-unit 3D finger language posture stored in the repository, and a syllable ground truth of finger language gestures stored in the repository; and an optimization unit configured to update the finger language recognition model in a way that reduces the calculated error, and the training data set may be produced by: estimating phoneme-unit 3D finger language postures from phoneme-unit 2D finger language videos; labeling the estimated phoneme-unit 3D finger language postures with phoneme ground truths of finger language gestures which match the phoneme-unit 2D finger language videos; generating syllable ground truths of finger language gestures by combining the phoneme ground truths of finger language gestures; generating a syllable-unit 3D finger language posture by combining the phoneme-unit 3D finger language postures corresponding to respective phonemes combined with the syllable ground truths of finger language gestures; and labeling the syllable-unit 3D finger language posture with the syllable ground truth of finger language gestures.

As described above, according to embodiments of the disclosure, by estimating 3D finger language postures from phoneme-unit 2D finger language videos and pseudo-labeling phoneme ground truths of finger language gestures, and producing, as a training data set, syllable-unit 3D finger language postures and syllable ground truths of the finger language gestures by combining the estimated 3D finger language postures and the phoneme ground truths, insufficient training data sets may be secured through augmentation without the time and cost burden.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating a finger language posture data set production system according to an embodiment of the disclosure;

FIG. 2 is a view illustrating a detailed configuration and functions of a 3D posture production unit′

FIG. 3 is a view illustrating a finger language posture data set production method according to another embodiment of the disclosure; and

FIG. 4 is a view illustrating a training system of a finger language recognition model according to still another embodiment of the disclosure.

### DETAILED DESCRIPTION

Hereinafter, the disclosure will be described in more detail with reference to the accompanying drawings.

Embodiments of the disclosure present a system and a method for producing a syllable-unit 3D finger language posture data set. The disclosure relates to a technique for producing a syllable-unit 3D posture data set by augmenting a phoneme-unit 2D finger language data set.

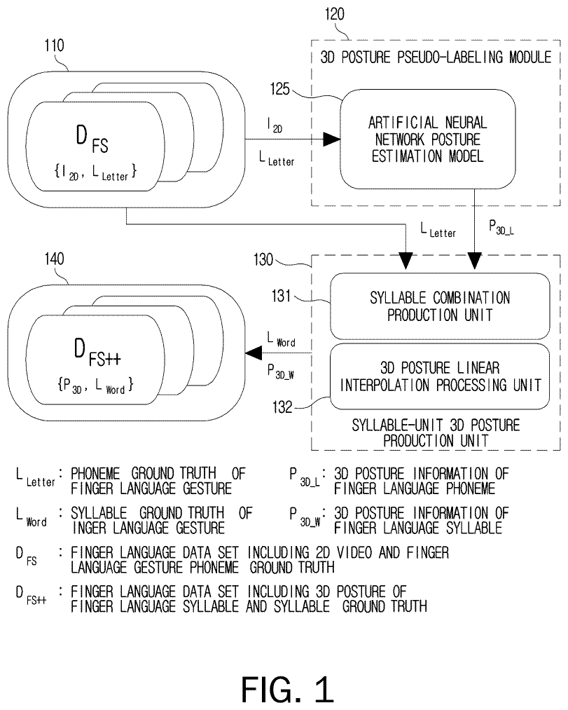

FIG. 1 is a view illustrating a configuration of a finger language posture data set production system according to an embodiment of the disclosure. As shown in FIG. 1, the finger language posture data production system according to an embodiment may be configured by including a phoneme-unit 2D finger language data set repository 110, a 3D posture pseudo-labeling module 120, a syllable-unit 3D posture production unit 130, and a syllable-unit 3D posture data set repository 140.

In the phoneme-unit 2D finger language data set repository 110, a phoneme-unit 2D finger language video I_{2D} and a phoneme ground truth L_{Letter} of a finger language gesture are pre-established as a data set. All of the videos and the ground truths (labels) constituting the data set are made in the unit of a phoneme.

The phoneme-unit 2D finger language video I_{2D} is a video that is made by shooting person's finger language gestures from the front in the unit of a phoneme, and may be implemented by any one of a color video or a depth video.

The 3D posture pseudo-labeling module 120 is configured to estimate a phoneme-unit 3D finger language posture P_{3D_L} from the phoneme-unit 2D finger language video I_{2D} established in the phoneme-unit 2D finger language data set repository 110, and may be configured by including an artificial neural network-based posture estimation model 125.

The artificial neural network-based posture estimation model 125 is an artificial intelligent (AI) model that is pre-trained to estimate a phoneme-unit 3D finger language posture P_{3D_L} from a phoneme-unit 2D finger language video I_{2D}.

The 3D posture pseudo-labeling module 120 may label the estimated phoneme-unit 3D finger language posture P_{3D_L} with the phoneme ground truth L_{LETTER} of the finger language gesture, as a pseudo-ground truth of the phoneme-unit 3D finger language posture P_{3D_L}, which matches the phoneme-unit 2D finger language video I_{2D} stored in the phoneme-unit 2D finger language data set repository 110, and may input the phoneme-unit 3D finger language posture P_{3D_L}, to the syllable-unit 3D posture production unit 130.

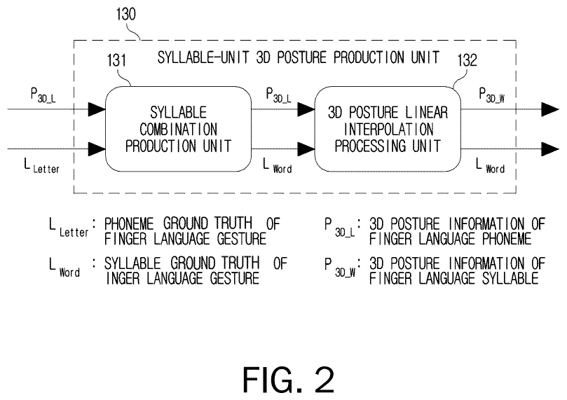

The syllable-unit 3D posture production unit 130 may produce a syllable-unit 3D posture data set by combining the phoneme-unit 3D finger language posture P_{3D_L} transmitted from the 3D posture pseudo-labeling module 120 and the phoneme ground truth L_{LETTER} of the finger language gesture. A detailed configuration and functions of the syllable-unit 3D posture production unit 130 will be described in detail below with reference to FIG. 2.

As shown in FIG. 2, the syllable-unit 3D posture production unit 130 may be configured by including a syllable combination production unit 131 and a 3D posture linear interpolation processing unit 132.

The syllable combination production unit 131 may produce (generate) a syllable ground truth L_{Word} of the finger language gesture by combining the phoneme ground truths L_{Letter} of the finger language gesture received from the 3D posture pseudo-labeling module 120.

The 3D posture linear interpolation processing unit 132 may produce (generate) a syllable-unit 3D finger language posture P_{3D_W} by combining the phoneme-unit 3D finger language postures P_{3D_L} corresponding to the phoneme ground truths L_{Letter} of the finger language gesture, which is combined with the syllable ground truth L_{Word} of the finger language gesture produced by the syllable combination production unit 131, according to the order of the phoneme ground truths L_{Letter} of the finger language gesture in the syllable ground truth L Word of the finger language gesture.

In combining the phoneme-unit 3D finger language postures P_{3D_L}, the 3D posture linear interpolation processing unit 132 may perform linear interpolation processing between the phoneme-unit 3D finger language postures P_{3D_L}. Linear interpolation between postures is for generating natural movements of hand joints between phonemes, and may be expressed by the following equation:

$${J}^{n + 1} = {J}^{n} + \{ ( a / L ) \times ( {J}^{m} - {J}^{n} ) \}$$

In the above equation, a and L are hyper parameters of linear interpolation, and the speed of finger language gestures may be adjusted by adjusting the hyper parameters. J^{m} and Jⁿ indicate the first 3D finger language posture of a later phoneme and the last 3D finger language posture of a prior phoneme, respectively. Linear interpolation may be performed between the phoneme-unit 3D finger language postures P_{3D_L}, so that continuous 3D finger language postures for a desired syllable may be obtained.

The 3D posture linear interpolation processing unit 132 may label the syllable-unit 3D finger language posture P_{3D_W} with the syllable ground truth L_{Word} of the finger language gesture, and may output the syllable-unit 3D finger language posture P_{3D_W} and the syllable ground truth L Word.

Referring back to FIG. 1, the syllable-unit 3D finger language posture P_{3D_W} and the syllable ground truth L_{Word} of the finger language gesture, which are outputted from the 3D posture linear interpolation processing unit 132, may be established in the syllable-unit 3D posture data set repository 130 as a data set. All of the videos and the ground truths (labels) constituting the data set are made in the unit of a syllable comprised of a plurality of phonemes.

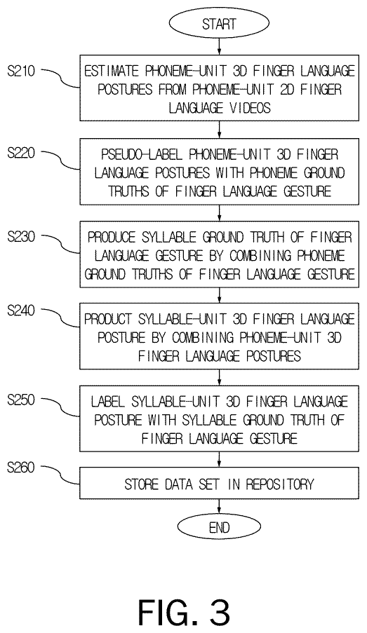

FIG. 3 is a flowchart illustrating a finger language gesture data set production method according to another embodiment of the disclosure.

In order to produce a syllable-unit 3D posture data set from a phoneme-unit 2D finger language data set, the artificial neural network-based posture estimation module 125 of the 3D posture pseudo-labeling module 120 may estimate phoneme-unit 3D finger language postures P_{3D_L} from phoneme-unit 2D finger language videos I_{2D} established in the phoneme-unit 2D finger language data set repository 110 (S210).

The 3D posture pseudo-labeling module 120 may label the estimated phoneme-unit 3D finger language postures P_{3D_L} with the phoneme ground truths L_{LETTER} of the finger language gesture, as pseudo-ground truths of the phoneme-unit 3D finger language postures P_{3D_L}, which match the phoneme-unit 2D finger language videos I_{2D} stored in the phoneme-unit 2D finger language data set repository 110 (S220).

The syllable combination production unit 131 of the syllable-unit 3D posture production unit 130 may produce a syllable ground truth L_{Word} of the finger language gesture by combining the phoneme ground truths L_{Letter} of the finger language gesture (S230).

The 3D posture linear interpolation processing unit 132 may produce a syllable-unit 3D finger language posture P_{3D_W} by combining the phoneme-unit 3D finger language postures P_{3D_L} corresponding to the phoneme ground truths L_{Letter} of the finger language gesture, which is combined with the syllable ground truth L_{Word} of the finger language gesture produced at step S230 (S240). In combining the phoneme-unit 3D finger language postures P_{3D_L}, the 3D posture linear interpolation processing unit 132 may perform linear interpolation processing between the phoneme-unit 3D finger language postures P_{3D_L}.

The 3D posture linear interpolation processing unit 132 may label the syllable-unit 3D finger language posture P_{3D_W} with the syllable ground truth L_{Word} of the finger language gesture (S250), and may store the syllable-unit 3D finger language posture P_{3D_W} and the syllable ground truth L_{Word} in the syllable-unit 3D posture data set repository 140 (S260).

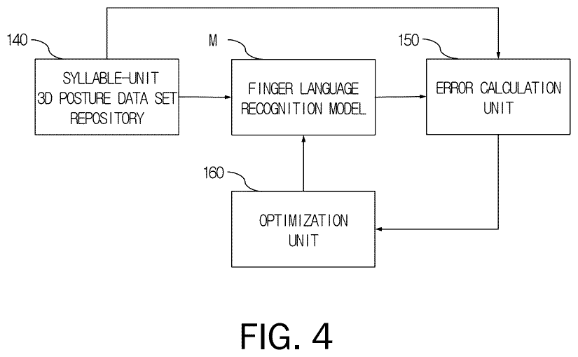

The data set stored in the syllable-unit 3D posture data set repository 140 at step S260 may be utilized for training a finger language recognition model, which is illustrated in FIG. 4. FIG. 4 is a training system of a finger language recognition model according to still another embodiment of the disclosure. The training system according to an embodiment may be configured by including a syllable-unit 3D posture data set repository 140, an error calculation unit 150, and an optimization unit 160.

A finger language recognition model M to be trained may estimate syllables of finger language gestures by receiving syllable-unit 3D finger language postures P_{3D_W} stored in the syllable-unit 3D posture data set repository 140.

The error calculation unit 150 may calculate an error by comparing the syllables of the finger language gestures estimated in the finger language recognition model M, and syllable ground truths L_{Word} of the finger language gestures stored in the syllable-unit 3D posture data set repository 140.

The optimization unit 160 may update the finger language recognition model M in a way that reduces the error calculated by the error calculation unit 150.

Up to now, a system and a method for producing a syllable-unit 3D posture data set by augmenting a phoneme-unit 2D finger language data set has been described in detail with reference to preferred embodiments.

In the above embodiments, by estimating 3D finger language postures from phoneme-unit 2D finger language videos and pseudo-labeling phoneme ground truths of finger language gestures, and producing, as a training data set, syllable-unit 3D finger language postures and syllable ground truths of the finger language gestures which are combinations of the estimated 3D finger language postures and the phoneme ground truths, insufficient training data sets may be secured through augmentation without the time and cost burden.

In the above embodiments, phoneme-unit 3D finger language videos are directly estimated from phoneme-unit 2D finger language videos by using an estimation model. However, phoneme-unit 2D finger language postures may be estimated from phoneme-unit 2D finger language videos, and then, the estimated phoneme-unit 2D finger language postures may be converted into phoneme-unit 3D finger language videos.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. A syllable-unit 3D finger language posture data set production method comprising:
a step of estimating phoneme-unit 3D finger language postures from phoneme-unit 2D finger language videos;
a first labeling step of labeling the estimated phoneme-unit 3D finger language postures with phoneme ground truths of finger language gestures which match the phoneme-unit 2D finger language videos;
a first generation step of generating syllable ground truths of finger language gestures by combining the phoneme ground truths of finger language gestures;
a second generation step of generating a syllable-unit 3D finger language posture by combining the phoneme-unit 3D finger language postures corresponding to respective phonemes combined with the syllable ground truths of finger language gestures; and
a second labeling step of labeling the syllable-unit 3D finger language posture with the syllable ground truth of finger language gestures.

2. The syllable-unit 3D finger language posture data set production method of claim 1, wherein the phoneme-unit 2D finger language videos and the phoneme ground truths of finger language gestures are pre-established in a first repository as a data set.

3. The syllable-unit 3D finger language posture data set production method of claim 2, wherein the phoneme-unit 2D finger language videos are videos that are made by shooting person's finger language gestures in the unit of a phoneme.

4. The syllable-unit 3D finger language posture data set production method of claim 1, wherein the step of estimating comprises estimating the phoneme-unit 3D finger language postures by using an AI model that is pre-trained to estimate phoneme-unit 3D finger language postures from phoneme-unit 2D finger language videos.

5. The syllable-unit 3D finger language posture data set production method of claim 1, wherein the first labeling step comprises labeling with the phoneme-unit ground truths of finger language gestures as pseudo-ground truths of the estimated phoneme-unit 3D finger language postures.

6. The syllable-unit 3D finger language posture data set production method of claim 1, wherein the step of producing the syllable-unit 3D finger language posture comprises combining the phoneme-unit 3D finger language postures by applying interpolation.

7. The syllable-unit 3D finger language posture data set production method of claim 1, wherein the second generation step comprises processing linear interpolation between the phoneme-unit 3D finger language postures in combining the phoneme-unit 3D finger language postures.

8. The syllable-unit 3D finger language posture data set production method of claim 7, wherein the linear interpolation between the phoneme-unit 3D finger language postures is processed by the following equation:
$${J}^{n + 1} = {J}^{n} + \{ ( a / L ) \times ( {J}^{m} - {J}^{n} ) \}$$
where a and L are hyper parameters of linear interpolation which are adjusted to adjust the speed of finger language gestures, and J^{m} and Jⁿ indicate the first 3D finger language posture of a later phoneme and the last 3D finger language posture of a prior phoneme, respectively.

9. The syllable-unit 3D finger language posture data set production method of claim 1, wherein the step of estimating comprises:
a step of estimating phoneme-unit 2D finger language postures from the phoneme-unit 2D finger language videos; and
a step of converting the estimated phoneme-unit 2D finger language postures into phoneme-unit 3D finger language videos.

10. A syllable-unit 3D finger language posture data set production system comprising:
a labeling module configured to estimate phoneme-unit 3D finger language postures from phoneme-unit 2D finger language videos, and to label the estimated phoneme-unit 3D finger language postures with phoneme ground truths of finger language gestures which match the phoneme-unit 2D finger language videos; and
a 3D posture production unit configured to generate syllable ground truths of finger language gestures by combining the phoneme ground truths of finger language gestures, to generate a syllable-unit 3D finger language posture by combining the phoneme-unit 3D finger language postures corresponding to respective phonemes combined with the syllable ground truths of finger language gestures, and to label the syllable-unit 3D finger language posture with the syllable ground truth of finger language gestures.

11. A training system comprising:
a repository configured to store a training data set in which a syllable-unit 3D finger language posture is labeled with a syllable ground truth of finger language gestures;
an error calculation unit configured to calculate an error by comparing a syllable of finger language gestures that is estimated by a finger language recognition model to be trained by receiving a syllable-unit 3D finger language posture stored in the repository, and a syllable ground truth of finger language gestures stored in the repository; and
an optimization unit configured to update the finger language recognition model in a way that reduces the calculated error,
wherein the training data set is produced by: estimating phoneme-unit 3D finger language postures from phoneme-unit 2D finger language videos; labeling the estimated phoneme-unit 3D finger language postures with phoneme ground truths of finger language gestures which match the phoneme-unit 2D finger language videos; generating syllable ground truths of finger language gestures by combining the phoneme ground truths of finger language gestures; generating a syllable-unit 3D finger language posture by combining the phoneme-unit 3D finger language postures corresponding to respective phonemes combined with the syllable ground truths of finger language gestures; and labeling the syllable-unit 3D finger language posture with the syllable ground truth of finger language gestures.
